(19) United States
(12) Patent Application Publication
(10) Pub. No.: US 2004/0202793 A1
(43) Pub. Date: Oct. 14, 2004

(54) Dip-spin coater

(76) Inventors: Bruce M. Harper, San Jose, CA (US); Andrew Homola, Morgan Hill, CA (US)

Correspondence Address: Daniel E. Ovanezian, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/410,039

(22) Filed: Apr. 8, 2003

(51) Int. Cl. B05D 1/18; B05C 3/00

(52) U.S. Cl. 427/430.1; 118/409; 118/400

(57) ABSTRACT

A dip-spin coating apparatus and method is described. A disk is partially immersed into a coating liquid and rotated while the disk is maintained in a substantially vertical plane. Once the disk is coated, the disk is removed from the coating liquid where excess material is spun off at a higher rotational speed while the disk is maintained in the vertical plane.

### TECHNICAL FIELD

Embodiments of this invention relate to the field of manufacturing and, more specifically, to the manufacturing equipment.

### BACKGROUND

Coating films have been applied to disks using various different methods such as dip coating, spin coating, dip-spin coating. In dip coating, a disk is dipped into a tank containing a coating liquid and then removed to have excess material drained from the disk. In prior dip-spin coating systems, an object is dipped in a horizontal plane into a tank containing a coating liquid. The object is then removed from the coating liquid and either spun in its horizontal plane to remove excess coating liquid or maintained stationary to allow excess material to drain from the object.

FIG. 1 illustrates a prior spin coating machine used to coat a disk. In some prior spin coating machines, a disk is placed in a horizontal plane on a spindle of the spin coating machine. The spin coating machine spins the disk in a horizontal plane and applies a coating liquid (e.g., in a drop-wise or stream manner) on the top surface of the disk. The rotational speed of the disk causes the coating liquid to be radially spread on the surface of the disk by virtue of centrifugal forces. The disk is then removed from the spin coating machine, partially dried and then returned to the coating spindle for coating of the other disk side. Because coating liquid is applied on each disk surface independently, the liquid maybe unevenly dispensed on both sides of the disk. This may result in coatings have varying thickness and qualities on each side. Moreover, since coating takes place one surface at a time, it takes twice as long to coat a disk than with dip coating machines. Additionally, the second coating operation may contaminate the previously coated surface with particles, over-spray and blowback.

A major portion of the applied coating liquid does not take part in the formation of the coating film but, rather, spins off from the surface of the disk. Another problem with prior spin coating machines is that the enclosure to contain the spun-off material creates backsplash on the previously coated surface thereby potentially rendering it useless. In addition, excess spun-off liquid is deposited and adheres to the sides of the coating chamber which may be blown back to the surface of successively treated disks. This may undesirably result in the development of pin-holes and projections in the coated film.

### BRIEF DESCRIPTION OF THE DRAWINGS

The present invention is illustrated by way of example, and not limitation, in the figures of the accompanying drawings in which:

FIG. 1 illustrates one embodiment of a prior art spin coating machine.

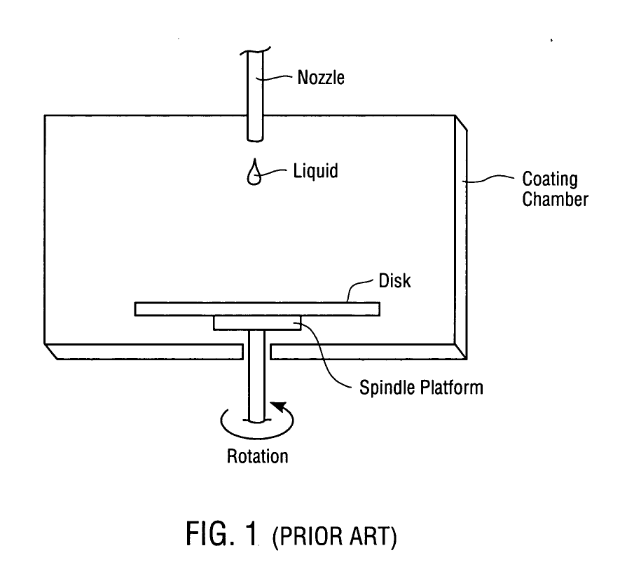

FIG. 2A illustrates one embodiment of a dip-spin coating machine having a disk in coating position.

FIG. 2B is a cross-sectional view illustrating of a portion of the machine of FIG. 2A.

FIG. 2C illustrates one embodiment of a dip-spin coating machine having a disk in a spin-off position.

FIG. 3A illustrates an alternative embodiment of a dip-spin coating machine having a movable tank.

FIG. 3B is a conceptual illustration of yet another embodiment of a dip-spin coating machine.

FIG. 4 is a flow chart illustrates one embodiment of a method of coating a substrate.

FIG. 5 illustrates one embodiment of a method of coating a substrate.

FIG. 6 illustrates one embodiment of a gang dip-spin mandrel.

### DETAILED DESCRIPTION

In the following description, numerous specific details are set forth such as examples of specific materials or components in order to provide a thorough understanding of the present invention. It will be apparent, however, to one skilled in the art that these specific details need not be employed to practice the invention. In other instances, well known components or methods have not been described in detail in order to avoid unnecessarily obscuring the present invention.

It should be noted that the apparatus and methods discussed herein may be used with various types of substrates. A substrate as used herein may a base object having one or more layers or materials disposed thereon or, alternatively, may not have any layers or materials disposed thereon. In one embodiment, for example, the apparatus and methods discussed herein may be used with a magnetic recording disk. Alternatively, the apparatus and methods discussed herein may be used with other types of digital recording disks, for example, optical recording disks such as a compact disc (CD) and a digital-versatile-disk (DVD). In yet another embodiment, the apparatus and methods discussed herein may be used with other types of substrates such as wafers (e.g., that are used in semiconductor manufacturing). Moreover, the substrate may have various shapes and dimensions. For example, when used for a magnetic recording disk, the substrate may be disk with a hole in its center. When used as a wafer for integrated circuit fabrication, the substrate may be substantially circular with a flat along a segment of its circumference. The substrate need not be circular or substantially circular and may have other shapes.

The terms “above” and “on” as used herein refer to a relative position of one layer with respect to the substrate or other layers. As such, one layer deposited or coated above or on the substrate (or other layer) may be directly in contact with the substrate surface (other layer) or may have one or more intervening layers.

A dip-spin coating apparatus and method are described. In one embodiment, the method includes rotating a disk while the disk is partially immersed in a coating liquid in a vertical plane. Once the disk is coated, the disk is extracted from the coating liquid and excess material is spun off while the disk is maintained in the vertical plane. In one embodiment, the disk is rotated at a higher rotational speed when extracted from the coating liquid than when the disk is rotated in the coating liquid. The dip-spin coating of a disk in a vertical plane may eliminate uneven surface coatings, back splash effects, and coat both sides of a disk simultaneously.

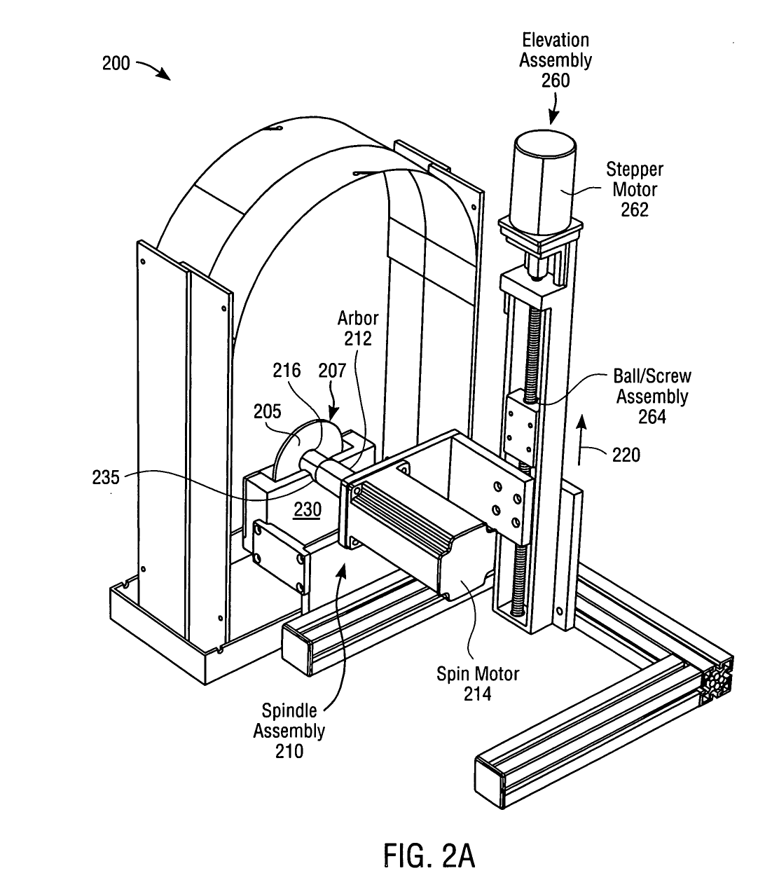

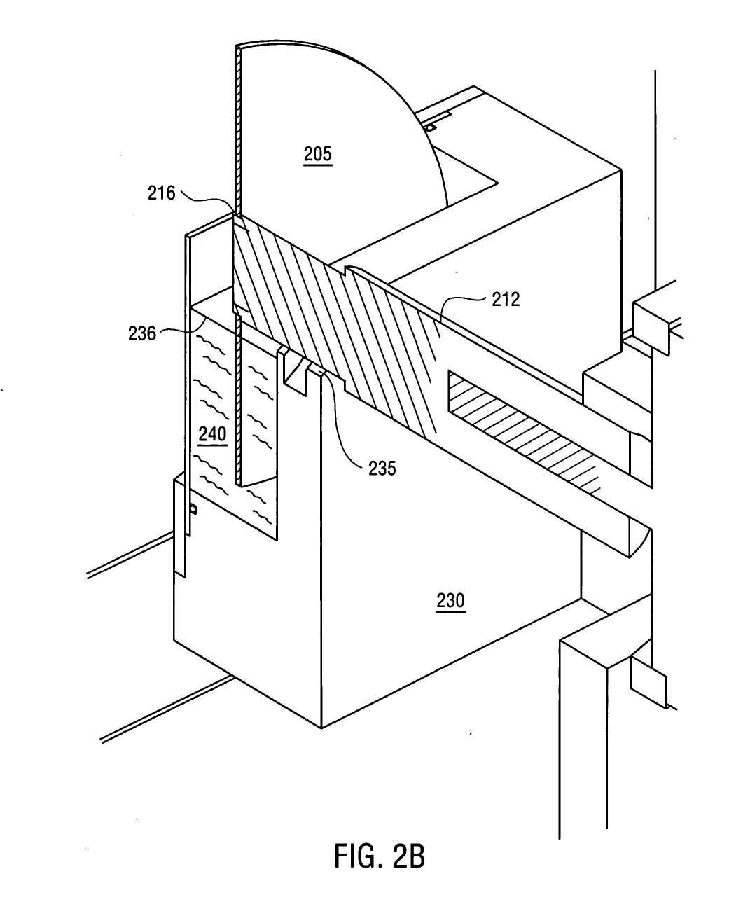

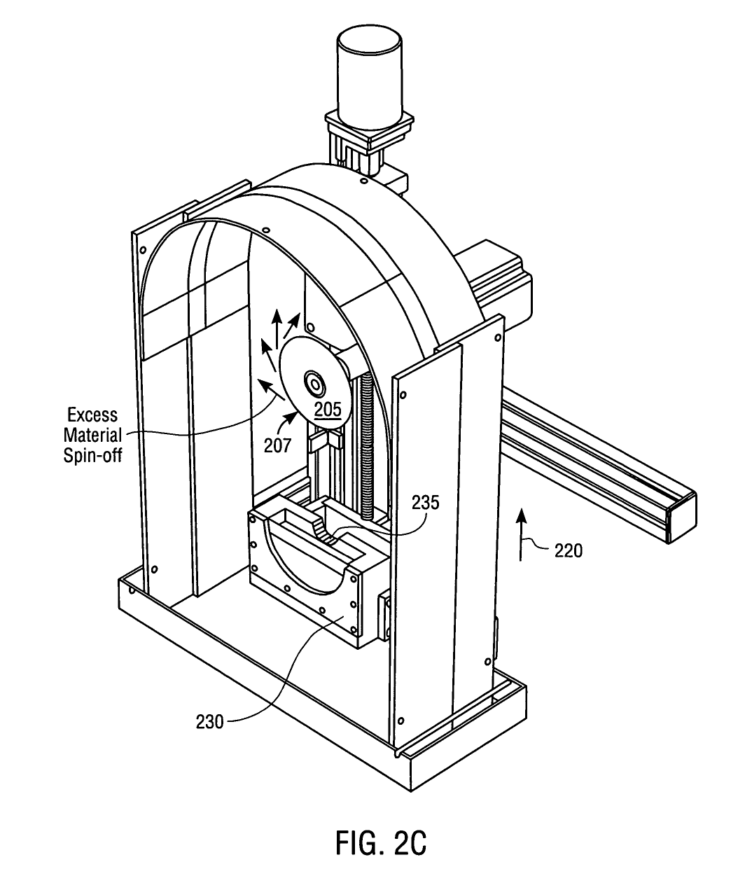

FIGS. 2A, 2B and 2C illustrate one embodiment of a vertical dip-spin coating machine. In one embodiment, the dip-spin coating machine 200 includes a spindle assembly having a horizontally disposed spindle arbor 212 coupled to a drive motor 214. The spindle arbor 212 has an expanding collet 216 on which to secure a substrate 205 having a cavity disposed therein. For example, the substrate 205 may be a disk having a cavity (e.g., a hole) disposed at its center. The disk 205 is secured to the spindle arbor 212 by sliding the inner diameter cavity edge of the disk 205 onto the expanding collet 216. The force from the expanding collet 216 on the inner diameter edge secures the disk 205 to the collet 216. When placed on the spindle arbor 212, the disk 205 is maintained in a vertical plane.

In an alternative embodiment, the disk 205 may be secured to the spindle assembly 210 using other means. For example, in one embodiment, the spindle arbor 212 may be replaced with a spindle shaft coupled to a spindle platform disposed in a vertical plane. The disk 205 may be secured to the spindle platform by, for example, vacuum means. The inner diameter region of the disk 205 may be positioned on the spindle platform such that the disk is maintained in the vertical plane. Yet other means may be used to secure the disk 205 to the spindle assembly, for example, using clips or grip arms that secure the disk 205 along the inner diameter or outer diameter edge of disk 205.

In one embodiment, spindle assembly 210 is configured for movement in a vertical direction 220. The spindle assembly 210 may be oscillated in vertical direction (up and down) 220 using an elevation assembly 260. Elevation assembly 260 may include, for example, a stepper motor 262 and slide and ball-screw assembly 264. Alternatively, other means may be used to move the spindle assembly 210, for examples, belts or cam-motor assemblies.

In-line with the disk plane is a coating tank 230 with a slotted opening 235 configured to receive spindle arbor 212. The coating tank 230 is configured to contain a liquid material 240 and a portion of disk 205 as illustrated by cross-sectional FIG. 2B. In one embodiment, a polymer such as poly methyl methacrylate (PMMA) dissolved in a suitable solvent may be used as the liquid material 240. In another embodiment, a lubricant solution such as perfluoropolyether or phosphazene may be used. Alternatively, other types of fluids may be used for the liquid material 240, for example, aqueous or non-aqueous solutions. In one embodiment, the coating tank 230 is filled up to approximately the overflowing level 236 of the slot 235 bottom. Alternatively, a lower level of liquid material 240 may be used.

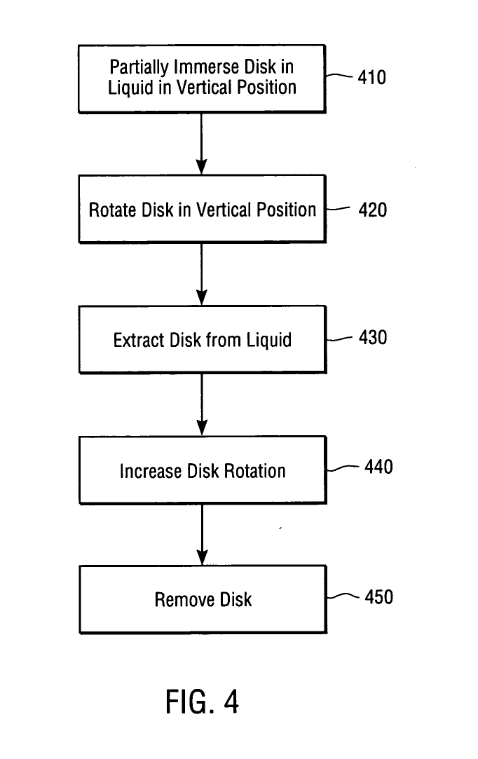

Elevation assembly 260 is used to raise and lower disk 205 into and out of the coating tank 240. Spindle assembly 210 is used to rotate disk 205 before, after and/or during partial immersion of disk 205 in the coating tank 240 as discussed below in relation to FIG. 4. For example, spindle assembly 210 may be used to rotate disk 205 after extraction from tank 240 in order to spin-off excess coating material 240 from the surfaces of disk 205, as illustrated in FIG. 2C.

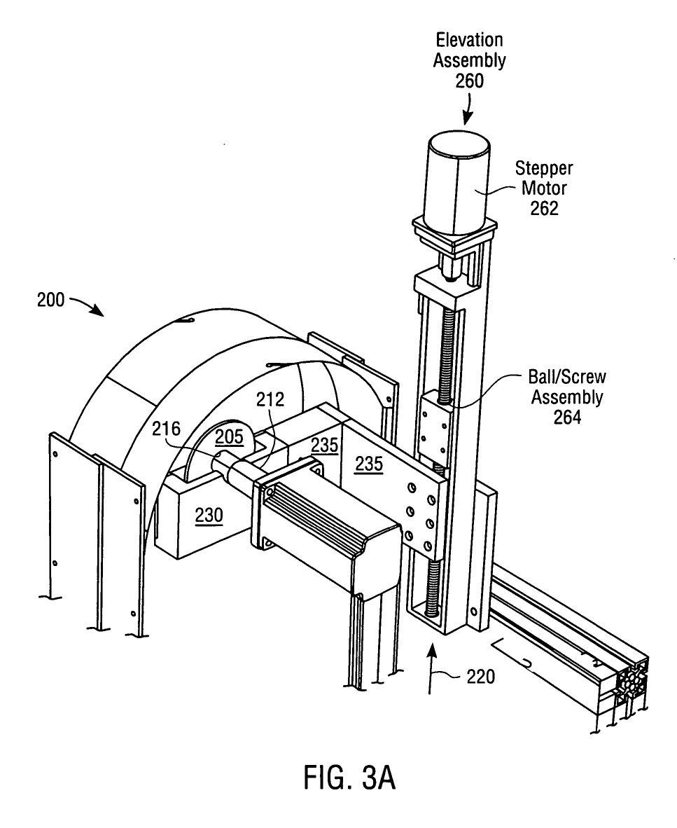

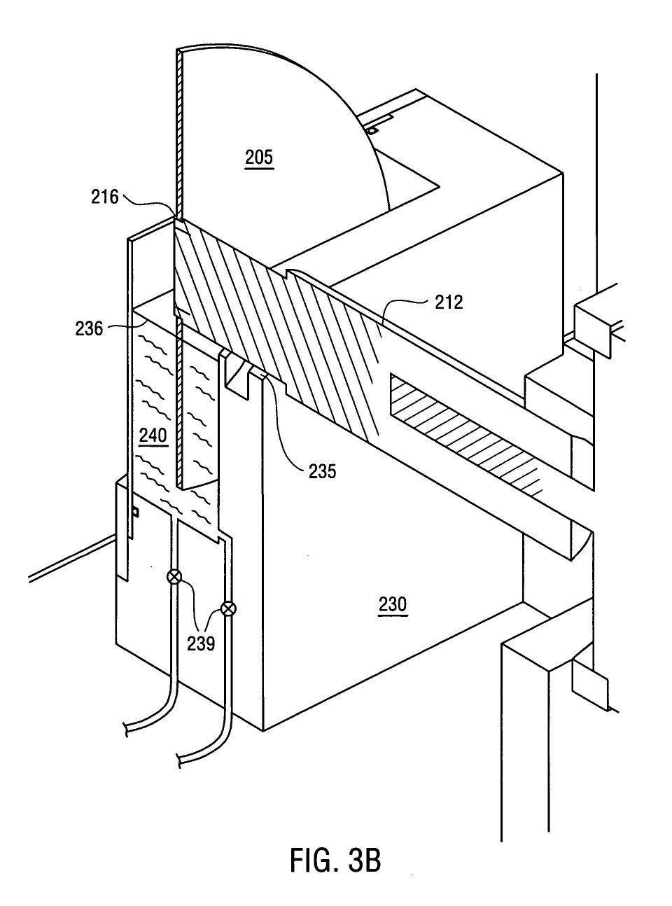

It should be noted that coating machine 200 may have various alternative configurations to perform the coating of disk 205 while disk 205 is maintained in substantially a vertical plane. In another embodiment, for example, the spindle assembly 210 may remain stationary while the tank 230 is movable (e.g., coupled to elevation assembly 260 via arm 235) to enable disk 205 to be dipped into and extracted from the liquid 240 in the tank 230, as illustrated in FIG. 3A. In yet another embodiment, for another example, both the tank 230 and spindle assembly 210 may remain stationary while the tank 230 is filled and drained of liquid 240 to enable the disk 205 to be partially immersed into and extracted from liquid 240 in the tank 230. In such an embodiment, the liquid 240 tank 230 may be drained and filled, for example, through control valves 239, as conceptually illustrated in FIG. 3B.

FIG. 4 is a flow chart illustrates one embodiment of a method of coating a substrate. In operation, the disk 205 is placed on the spindle arbor 212 in a vertical plane and then partially immersed into the coating liquid 240, step 410, while in the vertical plane. The extent that the disk 205 is partially immersed into the liquid 240 may vary from the outer diameter edge of disk 205 up to the boundary of the horizontal spindle arbor 212. At step 420, the disk is rotated while being partially immersed in liquid 240.

In one embodiment, disk 205 is partially immersed in the coating liquid 240 while being rotated, for example, at approximately 120 revolutions per minute (RPM). Alternatively, other rotational speeds may be used. In another embodiment, the disk 205 may be first lowered into the coating liquid 240, to any degree up to the boundary of the horizontal support arbor 212, before the disk rotation is begun.

After a predetermined time (e.g., on the order of upwards of seconds) of partially immersed coating, the disk 205 is extracted from the coating liquid 240, step 430. The disk 205 may be extracted from the coating liquid 240 while the disk is still rotated. Alternatively, the disk rotation may be slowed or stopped prior to extraction of the disk 205 from the coating liquid 240. After extraction from the coating liquid 240, the rotational speed of the disk/spindle may be increased, step 440, to a higher RPM whereby excess coating material residing on the disk's surfaces is spun off. For example, the rotational speed may be accelerated to 3,500 RPM. Alternatively, the rotational speed of the disk 205 may remain substantially the same as when the disk 205 is partially immersed in the coating liquid 240 to yield a thicker coating.

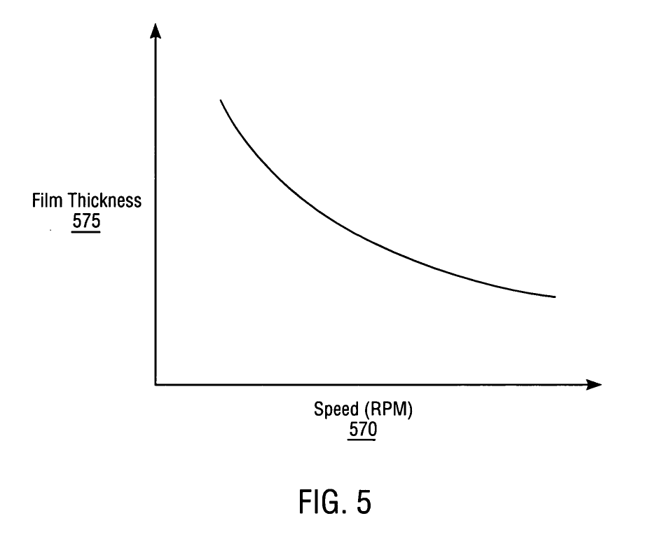

FIG. 5 illustrates an exemplary relationship between resulting film thickness and rotational speed. The rotational speed 575 of the disk 205 for a particular film thickness 575 may be determined by various factors including, the particular coating material used, viscosity, the desired film thickness of the coating material, environmental conditions, solvent ratio, temperature, etc. As such, the rotational speeds provided herein are only exemplary and other desired rotational speeds may be used. The determination of a particular rotational speed 575 based on contributing factors is known to one of ordinary skill in the art; accordingly, a more detailed discussion is not provided.

Referring back to FIG. 4, the disk 205 may then be air-dried and then removed form the spindle arbor 212 for further processing, step 450. The resulting coated disk 205 has both its sides coated with approximately an identical uniform coating.

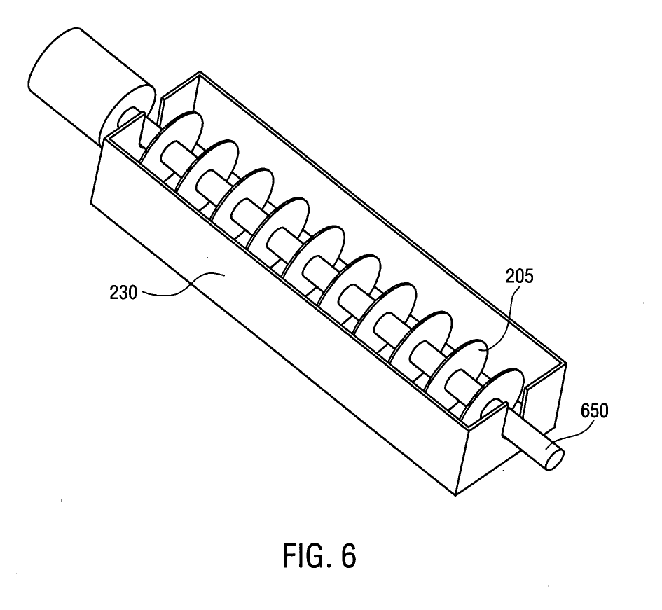

It should be noted that the method and apparatus discussed herein is not limited to dip-spin coating of only a single disk. In alternative embodiments, a plurality of disks may be maintained in substantially a vertical plane and dip-spin coated using, for example, a gang dip-spin mandrel. Dip-spin coating machine 200 may be configured for operation with a multiple disk mandrel 650 as illustrated in FIG. 6. In this embodiment, Mandrel 650 may contain one or more of disks 205 to enable simultaneous processing of multiple disks. Although mandrel 650 is illustrated as securing 10 disks 205, it may be configured to secure more or less than 10 disks.

The dipping and spinning of a disk while the disk is maintained in substantially a vertical plane may eliminate uneven surface coatings and back splash effects, and produce substantially uniform coatings both sides of a disk simultaneously. In addition, the methods and apparatus discussed herein produce disks having more uniform coating on both sides than prior coating systems.

As previously mentioned, the methods and apparatus discussed herein may be used with a substrate used to produce a magnetic recording disk. The substrate may be a base substrate without any layers disposed thereon such that the methods and apparatus discussed herein can be used to coat the base substrate, for example, with a resist layer. Alternatively, the substrate may have one or more layers that were previously disposed thereon such that the methods and apparatus discussed herein are used to provide a coat (e.g., a lubricant) over such layers. Also as previously mentioned, the method and apparatus discussed herein may be used with other types of substrates and in other types of industries. For example, the substrate may be an integrated circuit wafer and the methods and apparatus discussed herein may be used to provide a dielectric coating.

In the foregoing specification, the invention has been described with reference to specific exemplary embodiments thereof. It will, however, be evident that various modifications and changes may be made thereto without departing from the broader spirit and scope of the invention as set forth in the appended claims. The specification and figures are, accordingly, to be regarded in an illustrative rather than a restrictive sense.

1. A method of coating a substrate, comprising:
partially immersing the substrate into a liquid while the substrate is maintained in a substantially vertical plane;
rotating the substrate in the liquid; and
forming a substantially uniform coating on each side of the substrate.

2. The method of claim 1, wherein rotating comprises rotating the substrate in the liquid while the substrate is maintained in the substantially vertical plane.

3. The method of claim 1, wherein the substrate is rotated during the step of partially immersing the substrate into the liquid.

4. A method of coating a substrate, comprising:
partially immersing the substrate into a liquid while the substrate is maintained in a substantially vertical plane;
rotating the substrate in the liquid; and
extracting the substrate from the liquid while the disk is rotated.

5. The method of claim 4, wherein extracting comprises raising the substrate out of a tank containing the liquid.

6. The method of claim 4, wherein extracting comprises draining the liquid from a tank containing the liquid.

7. A method of coating a substrate, comprising:
partially immersing the substrate into a liquid while the substrate is maintained in a substantially vertical plane;
rotating the substrate in the liquid while the substrate is maintained in the substantially vertical plane:
extracting the substrate from the liquid; and
increasing the rotational speed of the substrate.

8. The method of claim 7, further comprising rotating the substrate while the substrate is extracted from the liquid.

9. The method of claim 8, wherein rotating comprises rotating the substrate in the liquid while the substrate in maintained in the substantially vertical plane.

10. The method of claim 9, wherein extracting comprises raising the substrate out of a tank containing the liquid.

11. The method of claim 9, wherein extracting comprises draining the liquid from a tank containing the liquid.

12. The method of claim 9, wherein extracting comprises lowering a tank containing the liquid.

13. The method of claim 1, wherein the substrate is a magnetic recording disk.

14. The method of claim 13, wherein the liquid comprises a polymer solution.

15. The method of claim 1, further comprising positioning the substrate on a spindle assembly, wherein the spindle assembly includes an arbor and wherein the arbor is not lowered into the liquid.

16. The method of claim 4, wherein extracting comprises lowering a tank containing the liquid.

17. A method of coating a substrate, comprising:
partially immersing the substrate into a liquid while the substrate is maintained in a substantially vertical plane:
rotating the substrate in the liquid:
simultaneously partially immersing a plurality of the substrates into the liquid while the plurality of substrates is maintained in a substantially vertical plane; and
rotating the plurality of substrates in the liquid.

18. A magnetic recording disk comprising a substrate processed in accordance with the method of claim 1.

19. A disk drive comprising a magnetic recording disk, the magnetic recording disk comprising a substrate processed in accordance with the method of claim 1.

20-26. (Canceled)

27. A coating apparatus, comprising:
means for partially immersing both sides of a substrate into a coating liquid while the substrate is maintained in a substantially vertical plane; and
means for rotating the substrate in the coating liquid.

28. The apparatus of claim 27, further comprising means for rotating the substrate while the substrate is being partially immersed into the coating liquid.

29. The apparatus of claim 28, further comprising:
means for removing the substrate from the coating liquid; and
means for increasing the rotational speed of the substrate.

30. The apparatus of claim 28, further comprising:
means for partially immersing both sides of a plurality of substrates into a coating liquid while the plurality of substrates is maintained in a substantially vertical plane; and
means for rotating the plurality of substrates in the coating liquid.

31. A method, comprising:
partially immersing a substrate into a liquid; and
simultaneously coating both sides of the substrate with the liquid with a substantially uniform film.

32. The method of claim 31, wherein simultaneously coating comprises rotating the substrate in a substantially vertical plane.

33. The method of claim 31, further comprising draining the liquid from a tank containing the liquid, wherein the liquid is drained to a level below the substrate.

34. The method of claim 31, further comprising:
partially immersing a plurality of substrates into a liquid; and
simultaneously coating both sides of each of the plurality of substrates with the liquid.

35. A magnetic recording disk comprising a substrate processed in accordance with the method of claim 31.

36. A disk drive comprising a magnetic recording disk, the magnetic recording disk comprising a substrate processed accordance with the method of claim 31.

37. The method of claim 1, wherein forming comprises:
extracting the substrate from the liquid; and
increasing the rotational speed of the substrate.

38. The method of claim 37, wherein the rotational speed of the substrate is increased to approximately 3,500 revolutions per minute.

39. The method of claim 7, wherein the rotational speed of the substrate is increased to approximately 3,500 revolutions per minute.

40. The method of claim 40, wherein simultaneously coating comprises:
extracting the substrate from the liquid; and
increasing the rotational speed of the substrate.

41. The method of claim 40, wherein the rotational speed of the substrate is increased to approximately 3,500 revolutions per minute.
